(19) United States
(12) Patent Application Publication
(10) Pub. No.: US 2025/0022075 A1
(43) Pub. Date: Jan. 16, 2025

(54) ENERGY OPTIMIZATION PLANT AND OPERATING METHOD THEREOF

(71) Applicant: NUOVO PIGNONE TECNOLOGIE -S.R.L., Florence (IT)

(72) Inventor: Ippolito FURGIUELE, Florence (IT)

(21) Appl. No.: 18/712,867

(22) PCT Filed: Nov. 15, 2022
(86) PCT No.: PCT/EP2022/025512

§ 371 Date: May 23, 2024

(30) Foreign Application Priority Data
Nov. 23, 2021 (IT) 102021000029597

(51) Int. Cl. G06Q 50/06; G06Q 30/0202; H02J 3/00; H02J 3/38

(52) U.S. Cl. CPC G06Q 50/06; G06Q 30/0202; H02J 3/003; H02J 3/381; H02J 2300/10

(57) ABSTRACT

An energy optimization plant for load peak applications. The plant has a power generation unit, which energy generated is switched to supply a distributed computing system for mining cryptocurrencies or to be injected into a power grid, for distributing electric power. A power control unit switches the power generated by the power generation unit based on data acquired from a communication network, such as the Internet.

### TECHNICAL FIELD

The present disclosure concerns an energy optimization plant, particularly a plant comprising a gas turbine intended to be used for producing energy in load peak applications, i.e., in applications where the electrical power is produced and sold only when there is a high demand for electrical power.

### Background Art

In the field of energy production, gas turbine plants are usually installed to supply energy in order to cover load peak applications. Specifically, when the power grid to which the gas turbine is connected, requires absorbing a peak of energy, such as during the summer, when the domestic and industrial coolers are all switched on in certain moment of the day, or other circumstances, the gas turbine of the plant start operating or increase the power generated, in order to supply the excess power demand.

The gas turbines typically employed in peak loading applications are system based on combustion of fuels. Energy transition will lead to clean fuels, such as H₂ and/or CH₃OH, NH3, biodiesel and biomethane Such fuels can be used as standalone fuels or blended with other fossil or clean fuels.

The operator of the plant operating the gas turbine, which inject energy into the power grid, is paid according to the current value of the energy as traded into the international energy markets.

Therefore, the operator has no choices as to know whether a better employment of the energy generated is available. For these reasons, also, the gas turbine plants are connected only and directly to the power grid.

An alternative possibility use of the energy, along with a system capable of deciding which source is more profitable, would be welcome in the field.

### SUMMARY

In general, cryptocurrency mining systems refers to the process of gaining cryptocurrencies by solving cryptographic equations with the use of high-power computers. The process involves verifying data blocks and adding transaction records to a public record known as a blockchain. There are facilities equipped with all the necessary equipment to mine cryptocurrencies such as Bitcoins, Ethereum, and/or other cryptocurrencies.

The mining of cryptocurrencies is high energy consuming. For instance, it is estimated that the Bitcoin network is consuming almost eighty terawatt-hours per year.

In one aspect, the subject matter disclosed herein is directed to an energy optimization plant for load peak applications. The plant comprises a power generation unit and a communication network, such as Internet and the like, through which information can be retrieved about technical and/or economical optimization parameters. The plant also comprises a distributed computing system for mining cryptocurrencies, which requires energy to operate, and power grid, for distributing electric power. The plant also comprises a power control unit, connected to the power generation unit and the distributed computing system. The power control unit is also connected to the communication network, for retrieving data. Through the power control unit is possible to switch the energy generated by the power generation unit into the power grid or to the distributed computing system, according to at least one energy optimization criterion, based on the one or more technical or economical optimization parameters.

In another aspect, the subject matter disclosed herein concerns the fact that technical or economical optimization parameters are function of energy data and cryptocurrency mining data concerning the price of electrical energy and the value of cryptocurrencies, such as Bitcoins and the like.

A further aspect of the present disclosure is drawn to the fact that the power generation unit is a gas turbine based on fossils and/or clean fuels and/or their blends. Specifically, the clean fuels comprise hydrogen or ethanol or methanol or ammonia or biogas or biodiesel. They can be used as a sole compound or blended with other clean fuels or fossils.

In another aspect, disclosed herein is a power switching device, for switching the energy generated by the power generation unit into the power grid or to the distributed computing system. In this connection, the power control unit comprises a processing unit configured for acquiring energy data and cryptocurrency mining data by the communication network.

A further aspect of the present disclosure is drawn to a method for switching the energy generated by a power generation unit. The method comprises the steps of acquiring, through a power control unit, energy data and cryptocurrency mining data by a communication network, evaluating the employment of the energy generated by a power generation unit based on the energy data and cryptocurrency mining data acquired in step, determining, in accordance with the energy optimization criterion, based on the one or more technical or economical optimization parameters, the convenience to supply energy to the distributed computing system or inject the power generated by the power generation unit into the power grid, and switching, by a power switching device, the energy generated by the power generation unit to the distributed computing system or to the power grid.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a schematic view of an energy optimization plant, according to an embodiment;

FIG. 2 illustrates a schematic view of a power control unit included in the energy optimization plant of FIG. 1; and

FIG. 3 illustrates a block diagram of an operating method, according to the energy optimization plant of FIG. 1.

### DETAILED DESCRIPTION OF EMBODIMENTS

In the field of the power generation unit gas turbines are often used to supply energy in case of peak energy demand of the power grid. In such circumstances, the energy produced by the gas turbine is usually paid based on the traded current energy price. The present disclosure concerns an energy optimization plant and an operating method thereof, capable of real time comparing the current traded energy price, and the value of one or more cryptocurrencies, to make a more profitable employment of the energy generated, possibly switching the energy produced to cryptocurrency mining systems, which require a remarkable amount of energy to operate.

In the following the switching operation of an energy optimization plant will be disclosed, for showing how the plant switches to possible alternative energy employment options.

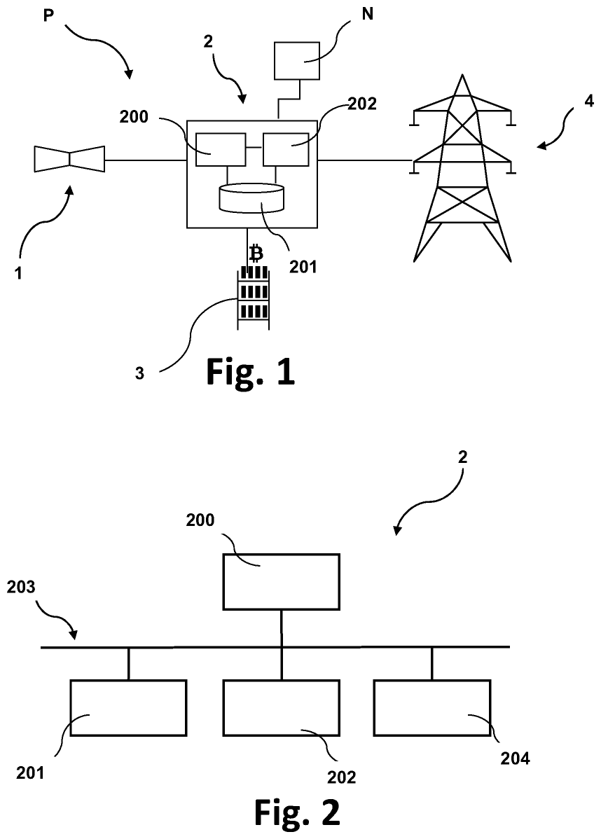

Referring now to the drawings, FIG. 1 shows an embodiment of an energy optimization plant, wholly indicated with the reference letter P. Hereafter, for ease of reference only, the energy optimization plant P may also be referred to as a plant P.

The plant P comprises, in general, a power generation unit 1, a power control unit 2, which is connected to the power generation unit 1, a distributed computing system 3, and a power grid 4. Both the distributed computing system 3 and the power grid 4 are connected to the power control unit 2 respectively.

As shown in FIG. 1, the power generation unit 1, such as a gas turbine and the like, is configured for generating power. In particular, in the embodiment the power generation unit 1 is a gas turbine and may be based on fossils and/or clean fuels and/or their blends, whereby it is possible to convert fuels into mechanical energy to produce electrical energy. According to the present disclosure, the clean fuels comprise hydrogen or ethanol or methanol or ammonia or biogas or biodiesel, which can be used as a sole compound or blended with other clean fuels or fossils. In other embodiments, other gases or fuels may be used.

The gas turbine can be activated whenever energy is required by the power grid 4.

As said, the power generation unit 1 is operatively connected to the power control unit 2, which, as it can be seen also referring to FIG. 2, comprises a circuit board, having thereon a bus 203, a programmable processor or processing unit 200, coupled with the bus 203, a computer readable memory or storage means 201 coupled with the bus 203, for storing data, and a human interface 204, such as a laptop or a computer in general, whereby a human operator can control or track the plant P operation. The power control unit 2 also comprise a power switching device 202 configured to for switching the energy generated by the power generation unit 1 into the power grid 4 or to the distributed computing system 3, having also input/output ports connected to the bus 203, configured to connect to the human machine interface 204.

Furthermore, according to the present disclosure, the power control unit 2 is also connected to a communication network N, i.e., a connected network system facilitating communication and access to data, such as Internet and the like, so as to acquire data from the communication network N concerning energy data and cryptocurrency mining data as well as information on one or more technical or economical optimization parameters. In other embodiments, the power control unit 2 may be connected to a computer or a plurality of computers connected to the communication network N.

The processing unit 200 is the functional part of the power control unit 2 of the plant P, according to the present disclosure. In particular, the processing unit 200 is equipped with calculating and processing means, configured to execute a computer program to make a profitable employment of the energy generated by the power generation unit 1, as well as for performing the interface with the other elements of the power control unit 2.

According to the present disclosure, the processing unit 200 is a microcontroller. However, in other embodiments, the processing unit 200 can comprise, for example, a computer or a plurality of computers, connected to each other in a network or cloud-connected.

Furthermore, the processing unit 200 is also configured to control and coordinate the operation of the elements of the power control unit 2, which it is connected and in communication with.

In particular, the processing unit 200 is configured for acquiring energy data and cryptocurrency mining data by the communication network N. Furthermore, the processing unit 200 is also configured to control the power switching device 202, thus controlling the switching of the energy generated by the power generation unit 1 into the power grid 4 or to the distributed computing system 3, in accordance with an energy optimization criterion, based on one or more technical or economical optimization parameters.

The one or more technical or economical optimization parameters are function of the energy data and cryptocurrency mining data. More specifically, according to the present embodiment, such optimization parameters are related to the current (in general real time) price of electrical energy, and the current value (in general real time) of the cryptocurrencies, such as Bitcoin or other alternative Coin, provided in real time by the communication network N to the processing unit 200. In other embodiments, such optimization parameters may be related to historical data, technical analysis and trends on electrical energy and cryptocurrencies.

Specifically, the programs executed by the processing unit 200 could be based not only on the current energy price and cryptocurrency value, but also on predictive based algorithms.

Therefore, the processing unit 200 is configured for determining, according to an energy optimization criterion based on at least one optimization parameter, the convenience to supply energy to the distributed computing system 3 or inject the power generated by the power generation unit 1 into the power grid 4.

As said, the power control unit 2 also comprises storage means 201. The storage means 201, such as for example a database, allow to store the historical energy data and the historical cryptocurrency mining data acquired by the processing unit 200 along the time, for example.

The storage means 201 are included in the power control unit 2. However, in other embodiments, the storage means 201 may be external to the power control unit 2 and operatively connected to the same.

As mentioned above, the power control unit 2 also comprises a power switching device 202 operatively connected to the processing unit 200. In particular, the power switching device 202 is configured for switching the energy generated by the power generation unit 1 into the power grid 4 or to the distributed computing system 3, upon a command from the processing unit 200.

The power switching device 202 may be a power semiconductor switch such as a metal-oxide-silicon transistor (MOSFET), insulated-gate bipolar transistor (IGBT) or bipolar junction transistors (BJT), designed to handle large amounts of power between the energy source and the relevant load. In other embodiments, the type of the power switching device 202 may be different.

The distributed computing system 3 is configured for mining of cryptocurrencies and requires energy to operate. In particular, according to the present disclosure, the distributed computing system 3 is a cryptocurrency mining farm, i.e., a facility equipped with all the necessary equipment to mine cryptocurrencies.

However, in other embodiments, the type and number of distributed computing system 3 may be different. For example, the distributed computing system 3 may comprise one or more structures, such as rooms or warehouses, housing a plurality of computers configured for mining one or several cryptocurrencies.

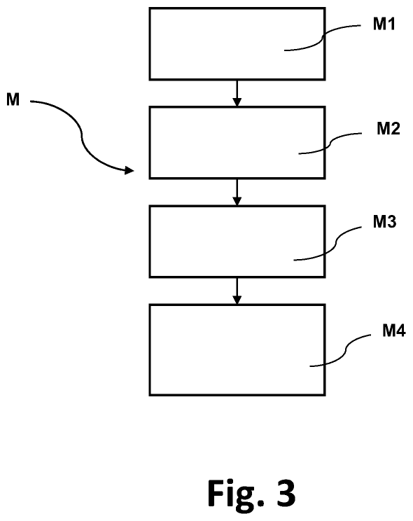

A block diagram of a method M for switching the energy generated by the power generation unit 1, according to the present disclosure, is shown in FIG. 3.

At first, the processing unit 200 of the power control unit 2 acquires (step M1) the energy data and cryptocurrency mining data by the communication network N.

Then, the processing unit 200 compares (step M2) the energy data and cryptocurrency mining data acquired in step M1. In other words, the processing unit 200 checks if the electricity price goes above the value of the cryptocurrencies or not. In other embodiments, the processing unit 200 can execute a more sophisticated algorithm for evaluating the more convenient energy employment, maybe based, as mentioned above, on historical data of the parameters, or on other additional technical or economical optimization parameters.

Then, in accordance with an energy optimization criterion based on at least one optimization parameter, the processing unit 200 determines (step M3), the convenience to supply energy to the distributed computing system 3 or inject the power generated by the power generation unit 1 into the power grid 4.

In particular, if it is convenient mining cryptocurrencies, the power control unit 2 switches (step M4), by the power switching device 202, the energy generated by the power generation unit 1 to the distributed computing system 3, to get a proportional amount of cryptocurrency.

Instead, if it is convenient injecting the power generated by the power generation unit 1 into the power grid 4, the power control unit 2 switches (step M4), by the power switching device 202, the energy generated by the power generation unit 1 to the power grid 4.

Furthermore, the power control unit 2 may also stop the crypto mining currently performed with the distributed computing system 3 in order to switchover to electrical energy production.

An advantage of the present disclosure is to provide a system capable of comparing, in real time, the current traded energy price and the value of one or more cryptocurrencies, to make a more profitable employment of the energy generated.

Another advantage of the present disclosure is to maximize the profit for peak loading applications wherein the gas turbine service factor is low through crypto mining.

While aspects of the invention have been described in terms of various specific embodiments, it will be apparent to those of ordinary skill in the art that many modifications, changes, and omissions are possible without departing form the spirt and scope of the claims. In addition, unless specified otherwise herein, the order or sequence of any process or method steps may be varied or re-sequenced according to alternative embodiments.

Reference has been made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

When elements of various embodiments are introduced, the articles “a”, “an”, “the”, and “said” are intended to mean that there are one or more of the elements. The terms “comprising”, “including”, and “having” are intended to be inclusive and mean that there may be additional elements other than the listed elements.

1. An energy optimization plant for load peak applications, comprising:
a power generation unit, for generating energy;
a communication network, for providing information on one or more technical or economical optimization parameters;
at least one distributed computing system for mining cryptocurrencies, which requires energy to operate;
a power grid, for distributing electric power; and
a power control unit, operatively connected to the power generation unit and to the distributed computing system, wherein the power control unit is also function-ally connected to the communication network, for retrieving data on the one or more technical or economical optimization parameters;
wherein the power control unit is configured for switching the energy generated by the power generation unit into the power grid or to the distributed computing system, in accordance with at least one energy optimization criterion, based on the one or more technical or economical optimization parameters.

2. The energy optimization plant of claim 1, wherein the one or more technical or economical optimization parameters are function of energy data and cryptocurrency mining data concerning the price of electrical energy and the value of cryptocurrencies.

3. The energy optimization plant of claim 1, wherein the power generation unit (1) is a gas turbine based on fossils and/or clean fuels and/or their blends.

4. The energy optimization plant of claim 3, wherein, the clean fuels comprise hydrogen or ethanol or methanol or ammonia or biogas or biodiesel, which can be used as a sole compound or blended with other clean fuels or fossils.

5. The energy optimization plant of claim 1,
wherein the power control unit comprises a power switching device configured for switching the energy generated by the power generation unit into the power grid or to the distributed computing system, and
wherein the power control unit comprises a processing unit configured for acquiring energy data and cryptocurrency mining data by the communication network.

6. The energy optimization plant of claim 5, wherein the processing unit is also configured for determining the convenience to supply energy to the distributed computing system or to the power grid, so as to control the power switching device for switching the energy generated by the power generation unit.

7. The energy optimization plant of claim 1, wherein the power control unit comprises storage means, connected to the processing unit, for storing the energy data and the cryptocurrency mining data acquired by the processing unit.

8. The energy optimization plant of claim 1, wherein the distributed computing system is a facility housing a plurality of computers configured for mining one or several cryptocurrencies such as Bitcoins and the like.

9. The energy optimization plant of claim 1, wherein the communication network is a connected network system facilitating communication and access to data, such as Internet and the like.

10. A method for switching the energy generated by a power generation unit, comprising the steps of:
acquiring, through a power control unit, energy data and cryptocurrency mining data by a communication network;
evaluating the employment of the energy generated by a power generation unit based on the energy data and cryptocurrency mining data acquired in step;
determining, in accordance with at least one energy optimization criterion, based on the one or more technical or economical optimization parameters, the convenience to supply energy to the distributed computing system or inject the power generated by the power generation unit into the power grid; and
switching, by a power switching device, the energy generated by the power generation unit to the distributed computing system or to the power grid.

11. The method of claim 10, wherein the step of evaluating the employment of the energy generated by a power generation unit comprises a comparison between the energy data and cryptocurrency mining data.

12. The method of claim 10, wherein the one or more technical or economical optimization parameters are function of energy data and cryptocurrency mining data concerning the price of electrical energy and the value of cryptocurrencies, such as Bitcoin or other Alternative Coin.
